(19) United States
(12) Patent Application Publication
(10) Pub. No.: US 2021/0237949 A1
(43) Pub. Date: Aug. 5, 2021

(54) Recyclable, Easily Tearable Packaging Laminate Having a Good Barrier Effect, and Method for The Production Thereof

(71) Applicant: Constantia Pirk GmbH & Co. KG, Pirk (DE)

(72) Inventors: Achim Grefenstein, Altrip (DE); Markus Kick, Weiden (DE); Thami Lamtigui, München (DE)

(21) Appl. No.: 17/269,453

(22) PCT Filed: Aug. 23, 2018
(86) PCT No.: PCT/EP2018/072774

§ 371 Date: Feb. 18, 2021

(51) Int. Cl. B65D 65/40; B32B 7/12; B32B 27/08; B32B 27/20; B32B 27/30; B32B 27/32; B32B 27/34; B32B 38/00; B29C 48/00; B29C 48/21; B29C 55/00; B29C 55/12

(52) U.S. Cl. CPC B65D 65/40; B29K 2023/065; B32B 27/08; B32B 27/20; B32B 27/306; B32B 27/32; B32B 27/34; B32B 38/0012; B29C 48/022; B29C 48/21; B29C 48/0018; B29C 55/005; B29C 55/12; B32B 2038/0028; B32B 2250/05; B32B 2250/24; B32B 2255/205; B32B 2255/10; B32B 2270/00; B32B 2307/412; B32B 2307/558; B32B 2307/582; B32B 2307/7244; B32B 2307/7246; B32B 2307/7248; B32B 2307/75; B32B 2553/00; B32B 7/12

(57) ABSTRACT

The present teaching relates to a recyclable, easily tearable packaging laminate having a good barrier effect, including a first laminate layer and a second laminate layer. The first laminate layer is a co-extruded and bidirectionally stretched composite consisting of a substrate layer having an HDPE content of at least 60 vol. %, a connecting layer and a barrier layer consisting of a barrier polymer, preferably polyamide or ethylene vinyl alcohol copolymer, having a thickness of maximum 20% of the total thickness of the first laminate layer. The connecting layer is arranged between the substrate layer and the barrier layer, and the first laminate layer is connected, at its barrier layer, to the second laminate layer.

### TECHNICAL FIELD

The present teaching relates to a packaging laminate comprising a first laminate layer and a second laminate layer, the first laminate layer comprising a barrier layer, and to a method for producing a packaging laminate of this kind.

### BACKGROUND

In the packaging industry, packaging laminates are used which are intended to have different properties depending on their application. Such packaging laminates are usually multilayer plastics films produced by means of an extrusion process, co-extrusion process (in both cases either a flat film process or blown film process) or lamination process (connection of individual layers by means of a laminating adhesive), or combinations of these processes. Layers not consisting of plastics material can also be integrated in the packaging laminate, for example a layer of aluminum or paper. The packaging laminate usually also has an outer sealing layer which allows the manufacture of the desired form of packaging, e.g., a sachet, a pouch, a bag, etc., thereof by heat sealing. In another application, a packaging laminate can also be designed as a shrink film, which, depending on its application, can also be produced having a sealable, but unprinted design, e.g., for the packaging of larger portions of meat.

A typical requirement for a packaging laminate is a barrier function against water vapor, oxygen, and aroma. For this purpose, the packaging laminate usually contains a barrier layer consisting of aluminum or a suitable barrier polymer, such as ethylene vinyl alcohol copolymer (EVOH) or polyamide (PA). In addition, further layers can also be contained to give the packaging laminate the desired properties, such as toughness, rigidity, shrinkability, tear resistance, etc. A sealing layer is typically made of a polyolefin, usually polypropylene (PP) or polyethylene (PE) with the various densities LLDPE, LDPE, MDPE or HDPE.

In order for it to be possible to process the packaging laminate easily, the packaging laminate obviously also must not warp or curl, and therefore symmetrical layer structures are usually used.

It is also known to change the properties of the packaging laminate by means of uniaxial or biaxial orientation. Such an orientation can be achieved by the extrusion process, for example in a multiple bubble extrusion process, or only after the extrusion process has been carried out, by stretching the packaging laminate in the machine direction (in the longitudinal direction of the packaging laminate) and/or in the transverse direction (normal to the longitudinal direction). Above all, the orientation of the packaging laminate can improve rigidity, tensile strength and toughness. Furthermore, the crystallization of the packaging laminate can be changed by the orientation such that even materials that are intrinsically somewhat cloudy, such as HDPE, are more transparent after stretching.

WO 2013/032932 A1 describes a packaging laminate of this kind, for example having the structure HDPE/connecting layer/EVOH/connecting layer/sealing layer, as a shrink film. In order to create the shrinkage property, the packaging laminate is biaxially stretched as a whole. Therefore, the stretching can only be carried out, however, once the individual layers of the packaging laminate have achieved a sufficient bond strength. The subject matter of WO 2009/017588 A1 is similar. However, WO 2013/032932 A1 and WO 2009/017588 A1 are primarily aimed at a suitable material for the connecting layer.

EP 673 759 B1 also discloses a packaging laminate for a shrink film, comprising a barrier layer consisting of EVOH, and at least one further polymer layer, which is to be compatible with the barrier layer in terms of stretching properties. An anhydride-modified linear low-density polyethylene (LLDPE) is specified as an example of the further polymer layer.

WO 2015/175871 A1 in turn describes a packaging laminate consisting of an HDPE layer, which is connected to a barrier layer, for example consisting of PA, vinyl containing polymers or acrylate-containing polymers. Furthermore, a sealing layer, for example consisting of LLDPE, can also be arranged on the barrier layer. The aim is to produce a recyclable laminate in which the barrier layer makes up a maximum of 5% of the total weight of the packaging laminate. The packaging laminate from WO 2015/175871 A1 is not oriented.

In many packaging items made from a packaging laminate, it is also desirable for the packaging to be easily tearable by hand, in particular for easy opening of the packaging. It is known, e.g., from WO 2005/113370 A1, that a unidirectionally stretched film can be more easily torn in parallel with the stretching direction than transversely thereto, and that such a film can also be torn in parallel with the stretching direction with a reduced tearing force by comparison with an unstretched or bidirectionally stretched film. Such a film can also be part of a laminate, which can also comprise a barrier layer consisting of aluminum or EVOH. The unidirectionally stretched film gives the laminate the good tear properties in parallel with the stretching direction and substantially prevents tearing transversely thereto.

EP 1 769 908 A1 in turn describes that a laminate consisting of a barrier layer (e.g., consisting of EVOH) and a plastics layer on both sides can easily be torn in both directions if the plastics layer consists of a mixture of PE having a density between 0.910 g/cm3 and 0.960 g/cm3 (i.e., LDPE, MDPE or HDPE) and a polycyclic olefin, such as a cyclic olefin copolymer (COC), and the laminate is subject to slight bidirectional stretching. Such slight bidirectional stretching occurs, for example, during extrusion in a blown film process, meaning that a separate step of orienting the laminate after extrusion can be omitted. However, due to the COC content, such a laminate can only be recycled to a limited extent and is also more complex to produce than a single-variety material. With a high COC content, with up to 60% COC in the mixture being mentioned, the laminate is no longer recyclable at all, at least if relatively large amounts of LDPE are also contained in the PE portions.

JPH6-262737 A1 describes a packaging laminate comprising an HDPE layer and a barrier layer, e.g., consisting of EVOH, having linear tear behavior. This document discloses that a unidirectionally or bidirectionally stretched packaging laminate leads to oblique tearing of the laminate and thus to uncontrolled opening behavior of a packaging produced therefrom. In order to overcome this problem, unidirectional rolling of the laminate is proposed, instead of stretching, and this should lead to linear tear behavior. The orientation in the longitudinal direction and transverse direction should not be less than 5 and the ratio of the orientation in the longitudinal direction and transverse direction should be in a range between 5 and 15. Such ratios are not achieved when a laminate is stretched. Typically, the ratio of the orientations in the case of bidirectional stretching is less than one.

### SUMMARY

An object of the present teaching is to provide a recyclable packaging laminate which can be easily produced, and which can be easily torn in both directions. Another object is to provide a method for producing a packaging laminate of this kind.

This object is achieved by co-extruding a first laminate layer consisting of a substrate layer having an HDPE content of at least 60 vol. %, a connecting layer and a barrier layer consisting of a barrier polymer, preferably polyamide or ethylene vinyl alcohol copolymer, having a thickness of maximum 20% of the total thickness of the first laminate layer, wherein the connecting layer is arranged between the substrate layer and the barrier layer, by subsequently bidirectionally stretching the co-extruded first laminate layer, and by subsequently connecting the bidirectionally stretched first laminate layer to a second laminate layer having a polyethylene content of at least 80 vol. %, wherein the second laminate layer is connected to the barrier layer of the first laminate layer. The packaging laminate according to the present teaching comprises a first laminate layer and a second laminate layer, wherein the first laminate layer is a co-extruded and bidirectionally stretched composite consisting of a substrate layer having an HDPE content of at least 60 vol. %, a connecting layer and a barrier layer consisting of a barrier polymer, preferably polyamide or ethylene vinyl alcohol copolymer, having a thickness of maximum 20% of the total thickness of the first laminate layer, wherein the connecting layer is arranged between the substrate layer and the barrier layer, and the first laminate layer is connected, at its barrier layer, to the second laminate layer.

As a result of the first laminate layer being bidirectionally stretched before being laminated with the second laminate layer, the barrier effect of the first laminate layer is significantly increased. In addition, it was surprisingly found that, due to the bidirectional stretching, the first laminate layer having the defined structure can be torn equally easily in both directions. These tear properties are imparted to the packaging laminate, and therefore the packaging laminate itself can also be easily torn in both directions. In addition, the simple asymmetrical structure of the first laminate layer simplifies production to a considerable extent by comparison with conventional symmetrical structures, which also significantly reduces production costs.

A stretched layer having a high HDPE content, in particular if the HDPE content is greater than 80%, tends to splice in the longitudinal direction. For this reason, in PE packaging laminates, MDO layers having a high HDPE content have so far always been combined with the tougher LLDPE or mLLDPE, for example by a further layer of LLDPE, with a high LLDPE content in the packaging laminate being sought. It was also surprisingly found that the first laminate layer having such a high HDPE content (even up to 100% HDPE) is sufficiently tough even without such a tough LLDPE layer and does not tend to splice. The reason for this is the connecting layer, which gives the laminate layer the required toughness. The first laminate layer can therefore also be used advantageously as a barrier film.

Due to the good transparency of the stretched HDPE substrate layer, the optical properties of the packaging laminate can be improved if the first laminate layer is printed, metallized or coated on the barrier layer before being connected to the second laminate layer. Metallization or coating can also further increase the barrier effect.

For certain applications, it is advantageous for the first laminate layer to be connected, at the substrate layer, to a further single- or multilayer laminate layer. The first laminate layer can be printed, metallized or coated on the barrier layer and/or on the substrate layer. Likewise, at least one layer of the further laminate layer can be printed, metallized or coated.

For certain applications, it is advantageous for the first laminate layer to be connected, at its substrate layer, to a unidirectionally or bidirectionally stretched fourth laminate layer, which has a substrate layer having an HDPE content of at least 60 vol. %, a barrier layer consisting of a barrier polymer, and a connecting layer arranged therebetween. A packaging laminate of this kind has particularly good barrier properties.

A further advantageous embodiment is obtained if the second laminate layer is a co extruded laminate stretched in the machine direction or bidirectionally and consisting of a substrate layer having an HDPE content of at least 60 vol. %, preferably at least 70 vol. % and very particularly preferably at least 80 vol. %, a connecting layer, a barrier layer consisting of a barrier polymer, preferably polyamide or ethylene vinyl alcohol copolymer, having a thickness of maximum 20% of the total thickness of the second laminate layer, and a sealing layer, the connecting layer of the second laminate layer being arranged between the substrate layer and the barrier layer of the second laminate layer and the sealing layer being arranged on the substrate layer, and the barrier layer of the second laminate layer being connected to the barrier layer of the first laminate layer. A packaging laminate of this kind also has particularly good barrier properties. In addition, the sealing layer is advantageously integrated in the co-extruded second laminate layer, and therefore no further production steps are required for the packaging laminate.

### BRIEF DESCRIPTION OF THE DRAWINGS

In the following, the present teaching will be explained in greater detail with reference to FIGS. 1 to 5, which show exemplary advantageous embodiments of the present teaching in a schematic and non-limiting manner. In the drawings:

FIG. 1 shows a first embodiment of a packaging laminate according to the present teaching,

FIG. 2 shows a second advantageous embodiment of a packaging laminate according to the present teaching,

FIG. 3 shows a third advantageous embodiment of a packaging laminate according to the present teaching,

FIG. 4 shows a fourth advantageous embodiment of a packaging laminate according to the present teaching, and

FIG. 5 shows an embodiment of a first laminate layer as a symmetrical barrier film.

### DETAILED DESCRIPTION

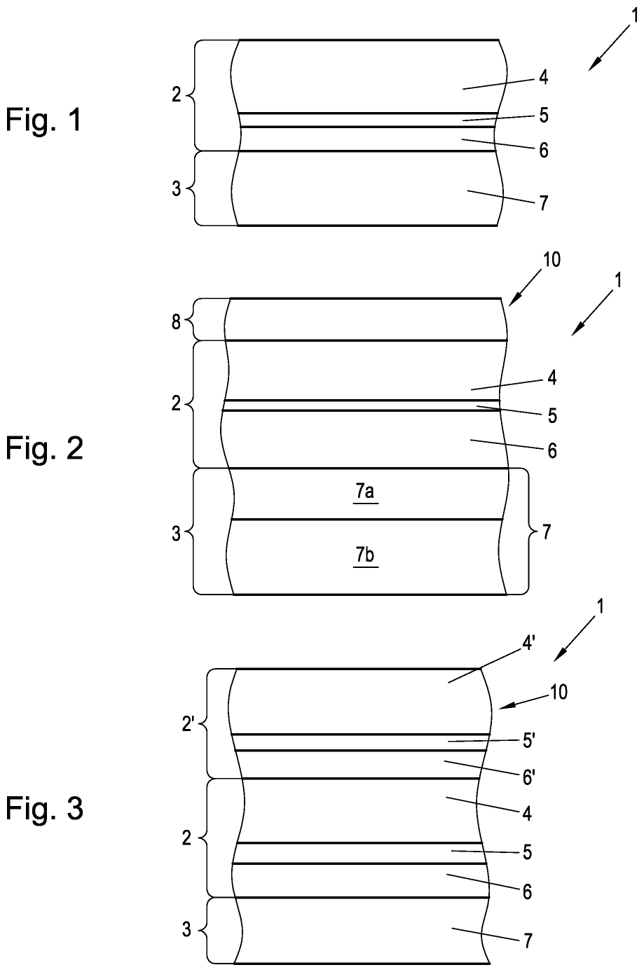

FIG. 1 shows a packaging laminate 1 according to the present teaching, comprising a first laminate layer 2 and a second laminate layer 3 connected to the first laminate layer 2.

The first laminate layer 2 in the packaging laminate 1 is stretched in the machine direction (MDO) and in the transverse direction (TDO), i.e., bidirectionally, and has an asymmetrical layer structure comprising a substrate layer 4 and a barrier layer 6 interconnected by a connecting layer 5. The thickness of the first laminate layer 2 is preferably 10 to 40 μm.

The substrate layer 4 has a content of high-density polyethylene (HDPE) of at least 60 vol. %, preferably at least 70 vol. % and very particularly preferably at least 80 vol. %. The HDPE content can reach up to 100 vol. %, however, due to common additives (such as slip additives, anti-block additives, fillers, etc.), 100 vol. % is usually not reached. An HDPE is understood to be a PE having a density between 0.94 and 0.97 g/cm³. The remainder is a compatible polyolefin material, preferably a linear low-density polyethylene (LLDPE) (having a density between 0.87 and 0.94 g/cm³), a low-density polyethylene (LDPE) (having a density between 0.915 and 0.935 g/cm³) or a metallocene linear low-density polyethylene (mLLDPE), in particular so as to increase toughness. In principle, any type of polyethylene is suitable as a compatible polyolefin material, in particular also ethylene copolymers, such as ethylene vinyl acetate copolymer (EVA), ethyl methacrylate (EMA), ethylene/acrylic acid copolymer (EAA) or ethylene butyl acrylate copolymer (EBA). Polypropylene (PP) or a cyclic olefin copolymer (COC) can also be used as a compatible polyolefin material in an amount of no more than 20 vol. %. In the case of PP, a polypropylene random copolymer with ethylene as comonomer (usually 5 to 15%), a polypropylene copolymer with ethylene or a polypropylene homopolymer that is sufficiently compatible with linear PE types, such as mLLDPE, LLDPE or HDPE, is preferably used in order to achieve at least limited recyclability.

The HDPE and the compatible polyolefin material can be present in the substrate layer 4 as a blend. The substrate layer 4 can, however, also have a multilayer structure (extruded or co-extruded) comprising one (or more) HDPE layer and one (or more) layer of the polyolefin material.

The thickness of the substrate layer 4 is preferably 5 to 35 μm.

The barrier layer 6 consists of a barrier polymer, i.e., a polymer having a sufficient barrier property, in particular against oxygen, water vapor and/or aroma. The barrier polymer is preferably a polyamide (PA) or an ethylene vinyl alcohol copolymer (EVOH). EVOH is preferred as the barrier polymer. The barrier layer 6 has a thickness of maximum 20%, preferably 5 to 10%, of the total thickness of the first laminate layer 2, i.e., a maximum of 2 to 8 μm. As a result of the low thickness of the barrier layer 6, recyclability is not impaired.

The connecting layer 5 is used to connect the barrier layer 6 and the substrate layer 4. A sufficient bond strength has to be achieved, in particular in order to reliably prevent undesired delamination of the first laminate layer 2. Suitable connecting layers 5 preferably consist of polymers of increased polarity, for example based on polyolefins (such as PE or PP) modified with maleic acid anhydride, ethylene vinyl acetate copolymer (EVA), ethylene/acrylic acid copolymer (EAA), ethylene butyl acrylate copolymer (EBA), or similar polyolefin copolymers. The thickness of a connecting layer 5 is at most 10% of the total thickness of the first laminate layer 2, typically 1 to 5 μm.

The second laminate layer 3 consists predominantly of a PE, wherein the PE content with respect to the total polymer amount of the second laminate layer 3, without any added mineral fillers or other fillers, should be at least 80 vol. %. Various PE types can be used, i.e., LDPE, LLDPE, MDPE, HDPE, in pure form or as a blend, or in the form of copolymers or also in multiple layers. The thickness of the second laminate layer 3 is typically between 20 and 200 μm, depending on the application of the packaging laminate 1.

In the second laminate layer 3 too, the remainder will of course consist of a compatible polyolefin material, as described above, in order to achieve the desired recyclability.

By using predominantly PE and compatible materials in the packaging laminate 1, a particularly recyclable laminate can be produced that can be easily and cost-effectively recycled using conventional methods in mechanical recycling.

The first laminate layer 2 is produced by co-extrusion, because this provides for particularly simple, cost-effective production. Preferably, the known blown film or flat film extrusion process is used.

After co-extrusion, the first laminate layer 2 is stretched bidirectionally, i.e., in the machine direction (usually the longitudinal or extrusion direction) and in the transverse direction (rotated 90° with respect to the machine direction). The degree of stretching in the machine direction and in the transverse direction need not be the same. The degree of stretching in the machine direction is preferably at least 4:1 to 8:1. The degree of stretching in the transverse direction is preferably at least 5:1 to 10:1. The stretching can take place in-line (i.e., immediately after co-extrusion) or off-line (i.e., at a later point in time after co-extrusion). The stretching can take place in the machine direction first and then in the transverse direction, or it is also conceivable for the stretching to take place in both directions at the same time. The stretching typically takes place at approx. 10° C. to 30° C., typically approx. 20° C., below the lowest melting temperature (for HDPE, approx. 128° C. to 130° C.) in the first laminate layer 2.

It should be noted here that, with blown film extrusion and flat film extrusion, the extrusion gap (1.5 to 2.5 mm for blown film) or the gap of the extrusion die is significantly larger than the end thickness of the extruded film (typically between 10 and 200 μm). For this purpose, the extruded melt is elongated at temperatures well above the melting point of the extruded polymer, giving it its final thickness. In blown film extrusion, for example, the melt is typically elongated in the transverse direction by approximately a factor of 2 to 3 (what is referred to as the blow-up ratio) and in the longitudinal direction by a factor of 1:10 to 1:100 (what is referred to as the drawdown ratio). However, this elongation during extrusion cannot be compared to stretching a plastics film, since stretching is usually carried out at temperatures just below the melting point of the polymer, in order to permanently align the disordered polymers and the partially crystalline regions by stretching in the stretching direction.

An asymmetrical structure of the first laminate layer 2 consisting primarily of polyethylene with bidirectional stretching is untypical and has so far been avoided in practice, in particular with blown film, since it had been assumed that such a structure would curl, in particular due to water absorption of the polar barrier layer 6, which would make further processing more difficult or impossible. It has been shown, however, that, with the specific design of the structure, curling occurs to an acceptable degree that does not hinder further processing. To this end, it is advantageous for the first laminate layer 2 to be connected to the second laminate layer 3 very soon after production in order to above all reduce the water absorption of the barrier layer 6. In certain circumstances, it may also be necessary or expedient to protect the co-extruded film roll comprising the first laminate layer 2 from water absorption by means of suitable packaging until lamination.

The main advantage of the untypical asymmetrical structure of the first laminate layer 2 is, however, that only a single expensive and not very rigid connecting layer 5 is required. The costs for the first laminate layer 2 can thus be reduced and a more rigid first laminate layer 2 can be achieved. The higher rigidity is particularly advantageous when the packaging laminate 1 is used to produce a pouch.

Further advantages of the first laminate layer 2 according to the present teaching result from the stretching. This stretching results in a high level of transparency, in particular of the substrate layer 4. By stretching the barrier layer, approximately three to four times higher barrier values are achieved by comparison with an unstretched barrier polymer of the same type, and therefore a less expensive barrier polymer can be used with the same barrier effect. This can significantly reduce the cost of the first laminate layer 2. In addition, less barrier polymer is required for the same barrier effect, which also improves recyclability.

The first laminate layer 2 is preferably produced using the multistage blown film extrusion process (e.g., triple or double bubble process), because this results in fewer edge trimmings resulting from production, which leads to lower costs for the packaging laminate 1, especially with the expensive barrier polymers. In blown film extrusion, more viscous HDPE materials having an MFI (mass flow index) of less than 3 can also be used. Such HDPE materials have a higher molecular weight and improved mechanical properties, which is favorable for use in a packaging laminate 1. However, such a material would tear particularly easily in the longitudinal direction and even lead to undesired splicing in the longitudinal direction. This undesirable property can be eliminated by integrating the HDPE material having an MFI of less than 3 in a first laminate layer 2, as described, and uniform tearing in both directions can even be achieved.

A bidirectionally stretched first laminate layer 2, comprising a substrate layer 4, a barrier layer 6 and a connecting layer 5, as mentioned, does not tend to splice in the longitudinal direction after the first step of stretching in the machine direction, despite the high HDPE content of 60 vol. %, in particular even with very high HDPE contents of greater than 80 vol. % to 100 vol. %, as was surprisingly found. This effect occurs both with an asymmetrical structure of the first laminate layer 2 and with a symmetrical structure of the first laminate layer 2.

It was surprisingly found that such a bidirectionally stretched first laminate layer 2 is substantially equally tearable in both directions, i.e., in the machine direction and transverse direction, and has controlled tear behavior.

For the first laminate layer 2 used as a barrier film 11 according to the present teaching, symmetrical structures are also possible (as shown in FIG. 5), however, for example in the form substrate layer 4 consisting of 100 vol. % HDPE/connecting layer 5/EVOH barrier layer 6/connecting layer 5/substrate layer 4 consisting of 100 vol. % HDPE. In one (or both) of the substrate layers 4, a low mLLDPE or LLDPE content (for example 5 to 10 vol. %) could also be added, preferably in one of the outermost layers, so as to modify the processing properties. In such a symmetrical structure, the two outer substrate layers 4 can also be thicker than the inner layers, for example in the form of an x/1/1/1/x structure, where x>1, in particular x=1.5, 2, 3 or 4.

Such a first laminate layer 2 alone as a barrier film 11 is also considered to be part of the present teaching and is characterized in particular by at least one substrate layer 4 which has an HDPE content of at least 60 vol. %, preferably at least 80 vol. %, and which is connected to a barrier layer 6 as described above by means of a connecting layer 5 as described above. The substrate layer 4 can also have a multilayer structure. In addition, for a symmetrical structure, the barrier layer 6 can be connected to a further substrate layer 4 as described above by means of a further connecting layer 5 as described above. Such a barrier film 11 is produced by co-extrusion and subsequent bidirectional stretching. The degree of stretching is preferably at least 4:1 to 8:1 in the machine direction and at least 5:1 to 10:1 in the transverse direction. The stretching can take place in-line (i.e., immediately after co-extrusion) or off-line (i.e., at a later point in time after co-extrusion), and either first longitudinally and then transversally or longitudinally and transversally at the same time.

To produce the packaging laminate 1, the stretched first laminate layer 2 and the second laminate layer 3 are interconnected, preferably by extrusion lamination, extrusion coating or adhesive lamination, the second laminate layer 3 being connected to the barrier layer 6 of the first laminate layer 2. In extrusion coating, the second laminate layer 3 is extruded onto the barrier layer 6 of the first laminate layer 2, preferably also with an adhesion promoter therebetween. In lamination, the second laminate layer 3 is connected to the barrier layer 6 by means of a suitable laminating adhesive, for example based on polyurethane adhesives or polyolefin copolymers for extrusion lamination. The thickness of the laminating adhesive is preferably 2 to 5 g/m² for conventional adhesives based on polyurethane or 5 to 20 g/m² for extrusion lamination.

When there are suitable second laminate layers 3, it has been found that the entire packaging laminate 1 also adopts the tear properties of the first laminate layer 2, i.e., the packaging laminate 1 can also be torn by hand equally easily in both directions. The first laminate layer 2 thus imparts the tear properties to the packaging laminate 1.

The second laminate layer 3 preferably forms a sealing layer 7 which, in packaging made from the packaging laminate 1, usually faces the packaged product. The packaging is produced by cutting, folding and heat sealing the packaging laminate 1. Possible forms of packaging are sachets, bags, pouches, etc.

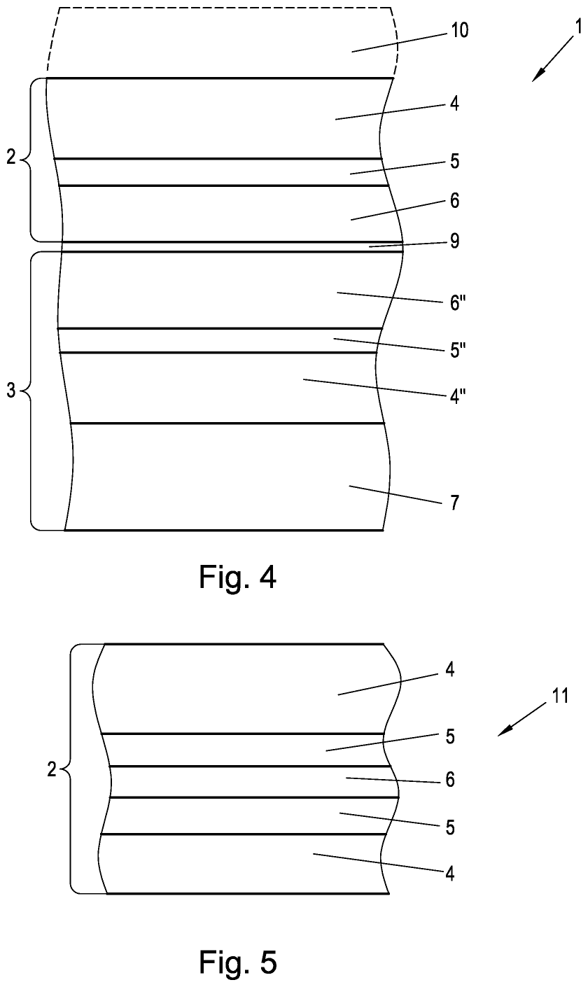

The second laminate layer 3 can also have a multilayer structure, for example extruded or co-extruded, as indicated in FIG. 2 and described in detail below. However, the second laminate layer 3 can also be provided with a barrier function and can also be stretched, as indicated in FIG. 4 and described in detail below.

In a further embodiment of the packaging laminate 1, as shown in FIG. 2, the first laminate layer 2 is connected on the side of the barrier layer 6 to the second laminate layer 3 and on the side of the substrate layer 4 to a further laminate layer 10, in this case a third laminate layer 8. The third laminate layer 8 is preferably a single- or multilayer polymer film, for example a film consisting predominantly of PE (at least 80 vol. % PE), as described with reference to the second laminate layer 3. The third laminate layer 8 can again either be extrusion-coated or adhesively laminated onto the first laminate layer 2, as explained with reference to the sealing layer 7 in FIG. 1. Such a packaging laminate 1 according to FIG. 2 can be used, for example, to produce tubes. In this case, the thickness of the second laminate layer 3 and the third laminate layer 8 is typically approximately 150 μm.

It is also indicated in FIG. 2 that the second laminate layer 3 can also have a multilayer structure, in this case for example with two layers 7a, 7b which form the sealing layer 7. The same applies to the third laminate layer 8. Such a structure of the second laminate layer 3 can of course also be provided in an embodiment according to FIG. 1.

It is also possible to metallize and/or print and/or coat (for example with aluminum oxide or silicon oxide) the stretched first laminate layer 2 on the barrier layer 6 after stretching and before connecting the first laminate layer 2 to the second laminate layer 3. Metallization with aluminum is preferred. The HDPE substrate layer 4 is sufficiently transparent, especially after stretching, so that the printed image, the metallization or the coating is visible through the substrate layer 4. For printing purposes, the barrier layer 6 can also be pretreated on the surface to be printed, for example by corona or flame treatment, in order to improve the adhesion of the printed layer to the barrier layer 6. However, alternatively or additionally, the substrate layer 4 can also be printed, metallized or coated, both on the side facing the barrier layer 6 and on the other side, if necessary again after surface treatment. Common printing processes can be used for this, for example gravure printing or flexographic printing.

The third laminate layer 8 could also be printed, metallized or coated on one or both sides, in addition to or as an alternative to the printing, metallization or coating of the first laminate layer 2.

In an advantageous design of the embodiment in FIG. 2, the barrier layer 6 of the first laminate layer 2 is metallized, preferably with aluminum, in order to increase the barrier effect. In addition, the third laminate layer 8 could be printed on the outside.

FIG. 3 shows a further embodiment of a packaging laminate 1 according to the present teaching, which can preferably be used to produce tubes. In this embodiment, the first laminate layer 2 is connected, at the barrier layer 6, to the second laminate layer 3, as in the example from FIG. 1. The first laminate layer 2 is connected, at its substrate layer 4, to a further laminate layer 10, in this case a fourth laminate layer 2′, which has the same structure as the first laminate layer 2 and which is stretched unidirectionally (in the machine direction) or bidirectionally. The fourth laminate layer 2′ thus in turn comprises a substrate layer 4′ which is connected to a barrier layer 6′ by a connecting layer 5′. The barrier layer 6′ of the fourth laminate layer 2′ is connected to the substrate layer 4 of the first laminate layer 2, preferably by means of a suitable laminating adhesive as described above. These layers of the fourth laminate layer 2′ are structured and designed as already described above. The fourth laminate layer 2′ consists primarily of PE materials having a PE content of at least 80 vol. %. The thicknesses and the exact compositions or materials of the individual layers of the first laminate layer 2 and the fourth laminate layer 2′ do not, however, have to be the same.

In this embodiment too, the fourth laminate layer 2′ can be printed, metallized or coated on the substrate layer 4′ and/or on the barrier layer 6′, in addition to or as an alternative to the printing, metallization or coating of the first laminate layer 2. In a particularly advantageous embodiment, the fourth laminate layer 2′ is printed, preferably on its barrier layer 6′, and the first laminate layer 2 is metallized, preferably on its barrier layer 6 or substrate layer 4. The barrier effect of the packaging laminate 1 can thus be increased. However, a coating of aluminum oxide or silicon oxide can also be provided on the barrier layer 6 or substrate layer 4 of the first laminate layer 2 in order to further increase the barrier effect.

FIG. 4 shows another advantageous embodiment of the present teaching. In this embodiment, the second laminate layer 3 again has a multilayer design and comprises a substrate layer 4″, a barrier layer 6″, and a connecting layer 5″, as with the first laminate layer 2. For these layers and also for the production of the second laminate layer 3, in this embodiment, the information given above in relation to FIGS. 1 to 3 for the first laminate layer 2 or fourth laminate layer 2′ applies analogously. In addition, the second laminate layer 3 comprises a sealing layer 7 in this embodiment. The sealing layer 7 preferably consists of a PE material such as mLLDPE, LLDPE, or another suitable thermoplastic, such as polypropylene (PP). However, this second laminate layer 3 having the sealing layer 7 still consists of at least 80 vol. % PE. The sealing layer 7 of the second laminate layer 3 is co-extruded with the other layers of the second laminate layer 3. The second laminate layer 3 in FIG. 4 is stretched, like the first laminate layer 2 and as described above. In this embodiment, the sealing layer 7 is therefore integrated in a multilayer stretched barrier film which has a similar structure to the first laminate layer 2. This second laminate layer 3 thus has substantially the same tear properties as the first laminate layer 2.

In this embodiment, the bidirectionally stretched first laminate layer 2 and the second laminate layer 3 stretched in the machine direction or bidirectionally are interconnected at the abutting barrier layers 6, 6″, preferably by adhesive lamination by means of an adhesive layer 9. A suitable laminating adhesive is, for example, an adhesive based on polyurethane or a polyolefin copolymer. The thickness of the lamination layer 9 is preferably 2 to 5 g/m².

In this embodiment, too, one (or more) of the layers of the packaging laminate 1 can be printed, metallized or coated.

Of course, in this embodiment, a further laminate layer 10 (for example a third laminate layer 8 or fourth laminate layer 2′ as described above) could also be provided on the first laminate layer 2, as indicated in FIG. 4.

The packaging laminate 1 according to the present teaching thus has at least an asymmetrical, bidirectionally stretched first laminate layer 2 consisting of at least 60 vol. % HDPE and comprising a substrate layer 4, a barrier layer 6 and a connecting layer 5, and a second laminate layer 3 which is connected to said first laminate layer, forms a sealing layer 7 and has a PE content of at least 80 vol. %. As described above, a further single- or multilayer laminate layer 10 (e.g., a third laminate layer 8 or fourth laminate layer 2′) having a PE content of at least 80 vol. % can be arranged on this packaging laminate 1 on the side of the first laminate layer 2 that faces away from the second laminate layer 3. This further single- or multilayer laminate layer 10 is thus connected to the substrate layer 4 of the first laminate layer 2.

In packaging made from a packaging laminate 1 according to the present teaching, the sealing layer 7 of the packaging laminate 1 advantageously faces the inside of the packaging.

By printing at least one layer of the first laminate layer 2, the second laminate layer 3 or the further laminate layer 10 of a packaging laminate 1 according to the present teaching with a barrier lacquer, for example polyvinyl alcohol (PVOH), the barrier effect of the packaging laminate 1 can also be further increased. Such lacquer layers can be applied very thinly, typically in the range of 0.5 to 2.0 g/m², and thus do not impair the recyclability of the packaging laminate 1.

Finally, it should be noted that each of the above-described individual layers in the first laminate layer 2, the second laminate layer 3 or the further laminate layer 10 can themselves also have a multilayer structure.

1. A method for producing a packaging laminate comprising:
co-extruding a first laminate layer consisting of a substrate layer having an HDPE content of at least 60 vol. %, a connecting layer and a barrier layer consisting of a barrier polymer, having a thickness of maximum 20% of the total thickness of the first laminate layer, wherein the connecting layer is arranged between the substrate layer and the barrier layer,
bidirectionally stretching the co-extruded first laminate layer,
connecting the bidirectionally stretched first laminate layer to a second laminate layer having a polyethylene content of at least 80 vol. %, wherein the second laminate layer is connected to the barrier layer of the first laminate layer.

2. The method according to claim 1, wherein the first laminate layer is printed, metallized or coated on the barrier layer before being connected to the second laminate layer.

3. The method according to claim 1, wherein the first laminate layer is connected, at the substrate layer, to a further single- or multilayer laminate layer having a polyethylene content of at least 80 vol. %.

4. The method according to claim 3, wherein the first laminate layer is printed, metallized or coated on the barrier layer and/or on the substrate layer before being connected to the further laminate layer.

5. The method according to claim 3, wherein at least one layer of the further laminate layer is printed, metallized or coated.

6. The method according to claim 3, wherein the first laminate layer is connected, at its substrate layer, to a further multilayer laminate layer in the form of a unidirectionally or bidirectionally stretched fourth laminate layer, which has a substrate layer having an HDPE content of at least 60 vol. %, a barrier layer consisting of a barrier polymer, and a connecting layer arranged therebetween, the barrier layer of the fourth laminate layer being connected to the substrate layer of the first laminate layer.

7. The method according to claim 1, wherein the first laminate layer is connected to a second laminate layer which consists of a substrate layer having an HDPE content of at least 60 vol. %, a connecting layer, a barrier layer consisting of a barrier polymer, having a thickness of maximum 20% of the total thickness of the second laminate layer, and a sealing layer, the layers being co-extruded, the connecting layer of the second laminate layer being arranged between the substrate layer and the barrier layer of the second laminate layer and the sealing layer being arranged on the substrate layer, and the co extruded second laminate layer being stretched in the machine direction or bidirectionally, and the barrier layer of the second laminate layer being connected to the barrier layer of the first laminate layer.

8. A packaging laminate comprising a first laminate layer and a second laminate layer, wherein the first laminate layer is a co-extruded and bidirectionally stretched composite consisting of a substrate layer having an HDPE content of at least 60 vol. %, a connecting layer and a barrier layer consisting of a barrier polymer, having a thickness of maximum 20% of the total thickness of the first laminate layer, wherein the connecting layer is arranged between the substrate layer and the barrier layer, and the first laminate layer is connected, at its barrier layer, to the second laminate layer.

9. The packaging laminate according to claim 8, wherein the barrier layer of the first laminate layer is printed, metallized or coated.

10. The packaging laminate according to claim 8, wherein the first laminate layer is connected, at its substrate layer, to a further single- or multilayer laminate layer having a polyethylene content of at least 80 vol. %.

11. The packaging laminate according to claim 10, wherein at least one layer of the further laminate layer is printed, metallized or coated.

12. The packaging laminate according to claim 10, wherein the further laminate layer is a fourth laminate layer in the form of a co-extruded composite stretched in the machine direction or bidirectionally and consisting of a substrate layer having an HDPE content of at least 60 vol. %, a barrier layer consisting of a barrier polymer, and a connecting layer arranged therebetween, and in that the substrate layer of the first laminate layer is connected to the barrier layer of the fourth laminate layer.

13. The packaging laminate according to claim 8, wherein the second laminate layer is a co-extruded laminate stretched in the machine direction or bidirectionally and consisting of a substrate layer having an HDPE content of at least 60 vol. %, a connecting layer, a barrier layer consisting of a barrier polymer, having a thickness of maximum 20% of the total thickness of the second laminate layer, and a sealing layer, the connecting layer of the second laminate layer being arranged between the substrate layer and the barrier layer of the second laminate layer and the sealing layer being arranged on the substrate layer, and in that the barrier layer of the second laminate layer is connected to the barrier layer of the first laminate layer.
